(19) United States
(12) Patent Application Publication
(10) Pub. No.: US 2013/0074158 A1
(43) Pub. Date: Mar. 21, 2013

(54) METHOD AND APPARATUS FOR DOMAIN-BASED DATA SECURITY

(71) Applicants: Olli Oskari Koskimies, Helsinki (FI); Olli Antero Rantapuska, Vantaa (FI); Jaakko Tuosa, Helsinki (FI)

(72) Inventors: Olli Oskari Koskimies, Helsinki (FI); Olli Antero Rantapuska, Vantaa (FI); Jaakko Tuosa, Helsinki (FI)

(73) Assignee: Nokia Corporation, Espoo (FI)

(21) Appl. No.: 13/236,857

(22) Filed: Sep. 20, 2011

(51) Int. Cl. G06F 21/00

(52) U.S. Cl. 726/4

(57) ABSTRACT

An approach is provided for a data application interface with improved security. The approach further involves processing a request for access to user data items to determine one or more associated domains and/or one or more access rules associated with the user data items. In one embodiment, the access rules specify criteria for determining one or more authorized domains and/or one or more users that have access rights to the user data items. The approach also involves determining whether to grant the access to the user data items based, at least in part, on a comparison of the determined domains against the criteria and/or access rules.

### BACKGROUND

Service providers and device manufacturers (e.g., wireless, cellular, etc.) are continually challenged to deliver value and convenience to consumers by, for example, providing compelling network services. A cloud phone is a mobile device in which all end-user functionality and data is downloaded and cached. Data in the device and the cloud is kept in sync automatically, making multiple device ownership effortless and allowing for the user to switch between different devices easily. The cloud phone concept requires a cloud data storage service which web applications can use to store and share data, and which automatically synchronizes data between the cloud and devices. The cloud concept, however, has security issues.

### SOME EXAMPLE EMBODIMENTS

Therefore, there is a need for an approach for providing a flexible and convenient data application interface for mobile web applications with improved security.

According to one embodiment, a method comprises determining a request for access to one or more user data items. The method also comprises processing and/or facilitating a processing of the request to determine one or more domains associated with the request. The method further comprises determining one or more access rules associated with the one or more user data items, wherein the one or more access rules specify, at least in part, one or more criteria for determining one or more authorized domains, one or more users, or a combination thereof that have access rights to the one or more data items. The method additionally comprises determining whether to grant the access to the one or more user items based, at least in part, on a comparison of the one or more domains against the one or more criteria, the one or more access rules, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine a request for access to one or more user data items. The apparatus is also caused to process and/or facilitate a processing of the request to determine one or more domains associated with the request. The apparatus is further caused to determine one or more access rules associated with the one or more user data items, wherein the one or more access rules specify, at least in part, one or more criteria for determining one or more authorized domains, one or more users, or a combination thereof that have access rights to the one or more data items. The apparatus is additionally caused to determine whether to grant the access to the one or more user items based, at least in part, on a comparison of the one or more domains against the one or more criteria, the one or more access rules, or a combination thereof.

According to another embodiment, a computer-readable storage medium carries one or more sequences of one or more instructions which, when executed by one or more processors, cause, at least in part, an apparatus to determine a request for access to one or more user data items. The apparatus is also caused to process and/or facilitate a processing of the request to determine one or more domains associated with the request. The apparatus is further caused to determine one or more access rules associated with the one or more user data items, wherein the one or more access rules specify, at least in part, one or more criteria for determining one or more authorized domains, one or more users, or a combination thereof that have access rights to the one or more data items. The apparatus is additionally caused to determine whether to grant the access to the one or more user items based, at least in part, on a comparison of the one or more domains against the one or more criteria, the one or more access rules, or a combination thereof.

According to another embodiment, an apparatus comprises means for determining a request for access to one or more user data items. The apparatus also comprises means for processing and/or facilitating a processing of the request to determine one or more domains associated with the request. The apparatus further comprises means for determining one or more access rules associated with the one or more user data items, wherein the one or more access rules specify, at least in part, one or more criteria for determining one or more authorized domains, one or more users, or a combination thereof that have access rights to the one or more data items. The apparatus additionally comprises means for determining whether to grant the access to the one or more user items based, at least in part, on a comparison of the one or more domains against the one or more criteria, the one or more access rules, or a combination thereof

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a flexible and convenient data application interface for mobile web applications with improved security, according to one embodiment;

FIG. 2 is a diagram of the components of a data store platform, according to one embodiment;

FIG. 3 is a flowchart of a process for providing a flexible and convenient data application interface for mobile web applications with improved security, according to one embodiment;

FIGS. 4A-4D are sequence diagrams of the processes of FIG. 3, according to various embodiments;

FIG. 5 is a diagram of a user interface for setting user preferences, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing a flexible and convenient data application interface for mobile web applications with improved security are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

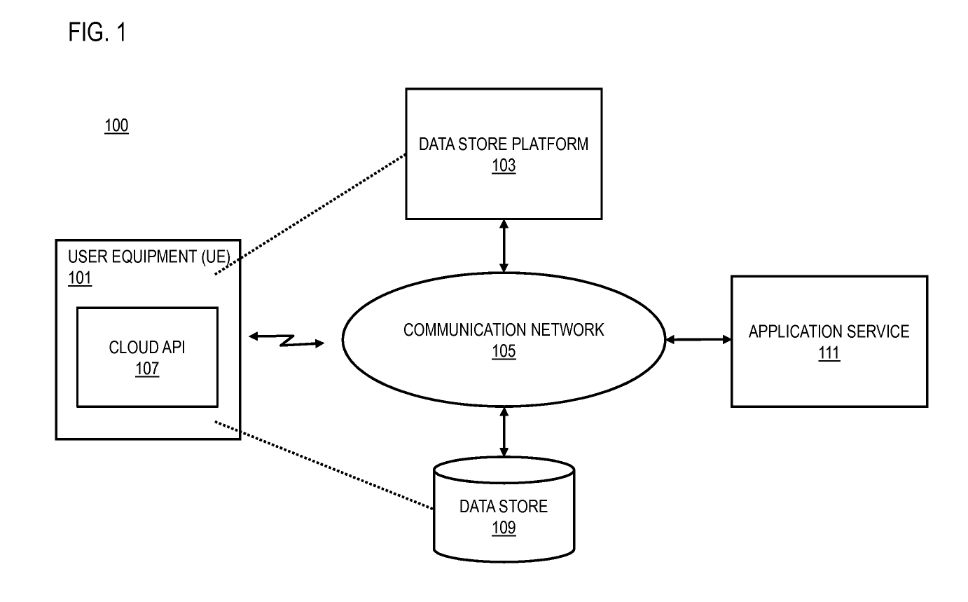

FIG. 1 is a diagram of a system capable of providing a flexible and convenient data application interface for mobile web applications with improved security, according to one embodiment. Web applications are sets of web pages from a single domain. There may be more than one application per domain, but security is domain-based so all applications in the domain have the same access rights (with regard to Cloud API). The web applications may be downloaded to a cloud capable phone, or may be a native application on the cloud phone.

Cloud phones are mobile devices in which all end-user functionality and data is downloaded and cached from the Web. Data in the device and the cloud is kept in sync automatically, making multiple device ownership effortless and allows the user to switch between different devices easily.

The cloud phone concept requires a cloud data storage service that web applications can use to store and share data, and that automatically synchronizes data between the cloud storage and associated devices. The cloud data storage service may be usable from a mobile device, from a PC browser and from a server. Multiple device ownership may be supported by the cloud data storage service (i.e., the same data is available on multiple devices, and kept in synch, by the cloud data storage service). While the cloud computing model has is advantages such as convenient synching and updating of data, there are a number of security risks involved with the cloud computing model.

Conventional data stores support only user-based access control. This means that a web page from any domain can access all of the user's data in the conventional data store. This is a security problem. The problem is enhanced by the fact that trusted clients cannot be assumed. Accordingly, it would be useless for a domain to encrypt its data, because the encryption key must be available to JavaScript running in the browser. It would be a trivial task for an attacker to use, for example, JavaScript debugging functionalities available in browsers to learn an application's encryption key.

Application keys are widely used by services to control access to REST APIs. They are application-specific passwords that a service allocates to client applications. An application must provide the application key in each service request in order to authenticate itself as an authorized client for the service. In many cases the application keys are not meant to be secret at all. The keys are simply a way for the service to tell applications apart for management purposes. The applications may be required to include the keys in clear text in web page JavaScript where they are easily accessible to anyone. In these cases the application key cannot be used for real access control because this is yet another security risk.

Some conventional cloud storage services allow service requests to come from a browser. This is accomplished by request pre-signing in which the server creates a digital signature for each possible request using a secret key that is never transmitted to the browser. The digital signatures are embedded in a generated HTML page and they are included in the requests sent by the page. This prevents an attacker from capturing the request in the browser before the browser can send it, after which the attacker could modify the request to perform an unauthorized operation and send it. The server, in this example, would detect that the signature does not correspond to the modified request and refuses to serve it. Additionally, the request can contain an expiration time after which the request is invalid.

The problem with the pre-signing approach is that the request needs to be known in advance by the server so that the signature can be created. This approach, in practice, prevents offline operation because it is not possible to know in advance the requests an interactive application will make. Partial signing cannot be used since in order for it to be effective, large parts of the request would have to be left unsigned which would create a security vulnerability.

To address these problems, a system 100 of FIG. 1 introduces the capability to provide a flexible and convenient data application interface for mobile web applications with improved security. As shown in FIG. 1, the system 100 comprises a user equipment (UE) 101 that has a cloud API 107 having connectivity to data store platform 103, a data store 109 and an application service 111 via a communication network 105. The UE 101 may have access to network 105 by way of the cloud API 107 which may itself be or have a browser feature, or a browser that is resident or accessible by the UE 101 remotely or locally for which the cloud API 107 provides permissions to access cloud data. The data store 109 may be remote, local, or both. Such a feature may allow for a redundant or singular database such that the data store 109, for example, may be accessible in an offline mode if the communication network 105 is not available. To facilitate this functionality, the data store platform 103 may also be remote and/or local to the UE 101.

The system 100 limits access on a per-domain basis, so that data in the data store 109 can be protected such that it can be accessed only by pages from the same domain such as cloud API 107 or application service 111 that stored the data, and from other domains to which access has been explicitly allowed.

A domain header field (called “Origin”) identifies the domain from which an HTML page that makes a request for data is fetched. The domain header field in cross-site Extensible Markup Language Hypertext Transfer Protocol Requests (XMLHttpRequests) is an existing browser feature that servers can use to limit access to a resource to certain domains.

A user of the system 100 owns all the data that is stored on his behalf in data store 109. As such, the system 100 provides for a security model for cases where either one user wants to access another user's data, or one application wants to access another application's data without help from the user. Application access restrictions to the data are enforced by the browser. Whenever the user has been successfully authenticated, normal browser security restrictions are in effect, and if the user has circumvented them, that is the user's choice, and the user can only hurt himself doing so. Users, however, cannot circumvent the security enforced by the system 100 based on user authentication.

Because the browser can be trusted when there is an authenticated user, XMLHttpRequests that carry data store requests can be trusted as well because they carry authentication information (which is needed for user-based access control). The originating domain field in the request may then be used to filter out data which is not accessible to that domain.

The system 100 provides security that is effective in both online and offline modes. The system 100 also provides security without the need for application developers to create server-side code for request signing.

Domain separation in an offline example may be maintained by the domain separation enforced by the cloud API 107. Data may also be stored in the domain of the page that originally fetched the data from the data store 109 by way of the data store platform 103.

User separation may be maintained by an operating system (“OS”) of UE 101 if the cloud API 107 includes a local, user-specific data storage that is used to store data from data store 109, and the OS protects the user-specific storage from unauthorized access (or at least clears the local storage at user switch). In the case of shared computers, for example, at internet cafes, any local storage must be cleared when the user leaves the computer to ensure privacy. This is similar to conventional security limitations associated with internet banking services.

The system 100 differs from conventional data store services because conventional data store services consider data to be owned by the application (developer). The application may grant access rights to users, but it is still the owner, and the application may override or modify user access rights at its whim. This is natural, since the customer of such storage services is the application developer (the users are customers of the application developer, not customers of the storage service). In the system 100, however, the data is owned by the user, and the user may in principle override or modify application access rights as he pleases. This has obvious benefits from user point of view; e.g. data migration can be enabled without application developer co-operation simply by allowing another application access to the data.

As discussed above, the requests to the data store platform 103 (which maintains the master copy of all data) may be made using cross-site XMLHttpRequest, and those requests contain the header, or origin, set by the cloud API 107 which identifies the domain that made the request (i.e., the domain from which the HTML page was fetched that made the request). Thus it is enough for data store platform 103 to verify that the domain in the request has access rights to the requested data available in the data store 109, and that the request carries valid user credentials for a user that has access rights to the data.

Effective access rights to data in the data store 109 are the access rights that are common to both the domain and the user—in other words, the intersection of the two sets of access rights. For example, if the user has read and write access to the object, and the domain has read and delete access, then the effective access right is read access. Similarly, if the user has no access and the domain has read and write access, the effective access right is no access.

Finally, it must be ensured that the domain protection remains in force when accessing data in offline mode. The system 100 accomplishes this by storing it in the data store 109 (which may be local (e.g. SQL) storage) which has a different storage area for each domain. Whenever data is read from the data store platform 103 in an online mode, it is also cached in the data store 109, or a local storage in the storage area for the domain from which the web page making the read originated. It will therefore only be accessible to pages from the same domain.

An advantage of the system 100 is that it allows applications to control access to their data on a per-domain basis, in addition to user-based access control. This enables data to be shared between applications in a controlled and uniform way, and prevents rogue applications from accessing private data even though all applications use the same data storage facility and operate on behalf of the user (i.e., a user having valid user credentials).

Also, since the user has ultimate control over his data, applications cannot rely on data access control in cases where the user has incentive to aid in compromising the data. For example, an application might implement user-specific price offers and save pricing related data in the data store. A second application might offer the same product “always 10% cheaper” but require that the user allows it to see the pricing data of the first application to verify the pricing. This would require the user to explicitly agree to grant the access rights, but a sufficient number of users might agree to this so that the second application would be able to build an accurate picture of the pricing model of the first application. Rather than storing their sensitive data as user-owned data, applications should have their own account in the data store platform that allows them to store data that is accessible only to the application. Assuming that access control policies are used to prevent access by other user accounts, users can access such data only via the service application 111.

Native applications can also use the system 100, but this requires that the native applications are associated with a domain in a secure way. This association prevents the application from falsifying the domain that is belongs to.

One example of associating the application with the domain is that the application was downloaded from the domain using, for example, HTTPS so that the domain name cannot be spoofed. Another example is that the application was downloaded from an application store and the application store download includes a digitally signed manifest that contains the domain name of the application. Another example is that each domain has a list of applications on the domain's server, e.g., under applist.xml. The list contains a checksum (e.g. MD5) for each application. Each application identifies the name of the application and which domain it belongs to at installation time (e.g., using an application manifest). This is verified by downloading the application list for the domain using SSL to guarantee authenticity and checking that the application is found on the list and that the checksum matches. For example, if an application manifest states that the name of the application is “Example App” and the application originates from “Example.com,” then at installation, the client would download the file https://example.come/applist.xml. The client would also verify that the file contains an application called “Example Application” and that the checksum listed in the file is the same as the checksum of the application that is about to be installed.

In the case of securing the data accessed by a native application, the native application also needs to be run in a sandbox that forces the native applications to access the data store data, whether remotely or cached, only in a controlled way so that the access control is maintained.

The system 100, in one or more embodiments, may for example, provide a remote API to web applications using XMLHttpRequest, allow web applications to specify which users and which domains can access a stored entity, implement user-based access control based on user credentials included in application request, implement domain-based access control based on both a domain header field (e.g. “Origin”) set by the cloud API 107 (which may be a browser) and user credentials included in application request, and provide access rights to data that corresponds to the intersection of the set of access rights owned by the current user, and the set of access rights owned by the current domain.

By way of example, the UE 101, data store platform 103, data store 109 and application service 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

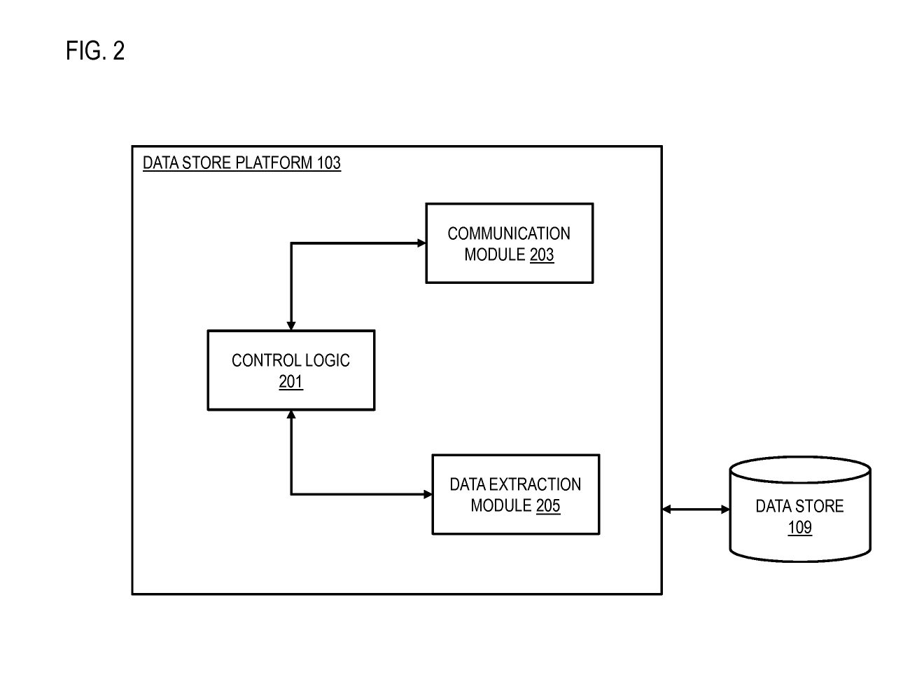

FIG. 2 is a diagram of the components of data store platform 103 according to one embodiment. By way of example, the data store platform 103 includes one or more components for providing a flexible and convenient data application interface for mobile web applications with improved security. It is contemplated that the functions of these components may be combined in one or more components or performed by other components of equivalent functionality. In this embodiment, the data store platform 103 includes a control logic 201, a communication module 203 and a data extraction module 205.

In one or more embodiments, the communication module 203 communicates with the cloud API 107, the application service 111 and the data store 109. If a user requests to access data that is stored in the data store 109 by way of the cloud API 107 or the application service 111, the request is received by the communication module 203. The control logic 201 determines the type of request and causes the extraction module 205 to access the data store 109 so that the data may be provided and/or manipulated based on a series of rule for determining one or more authorized domains from which a request may originate, one or more authorized users, or any combination thereof to access the data. The control logic 201 determines the domain associated with the originating request and compares the domain to the authorized domains that are known to allow access to the data. The determination may be based on one or more headers associated with the request. Further, the data extraction module may apply one or more filters based on a comparison of the determined domain with one or more rules that allow for a particular domain to have access to the data. The filters may allow for limiting search results of data available in the data store 109.

The control logic 201 may also process a request for data to determine one or more credentials associated with one or more users. Once the credentials are determined, the data extraction module 205 determines grantable access rights based on the credentials and allows for access to the data store 109 based on a comparison of the request with the grantable access rights. For example, a user may have access credentials for accessing only one type of data available in the data store 109, or none of the data at all. The access rights may also be a type of access rights such as read/write, read only, delete access, etc. Any determined rights may be based only on any matching rights so that a user may not be granted with more rights than intended for that user. This prevents an improper or rogue user from deleting or modifying data in the data store 109 unexpectedly.

The control logic 201 also determines whether the cloud API 107, application service 111 and/or the data store 109 are online or offline, and/or the network 105 is available. If offline, or the network 105 is not available, the one or more data items from the cloud API 107 and/or the application service 111 are cached in one or more offline data stores 109 that are resident on the UE 101 associated with the domain of the cloud API 107 and/or the application service 111. In the case of an offline data store 109, the data store 109 is a local storage associated with the cloud API 107(i.e. a browser).

The control logic 201 determines the origin of the request (e.g., from one or more application services 111 and/or other services or applications via the cloud API 107) and causes the access rules to be maintained by any combination of developers, content stores or third parties.

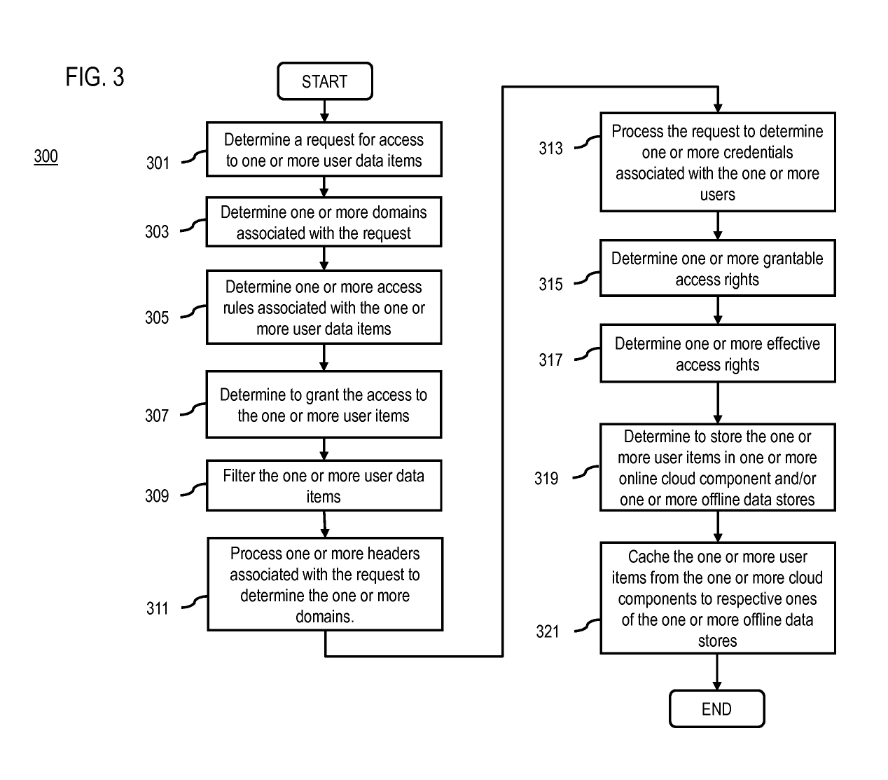

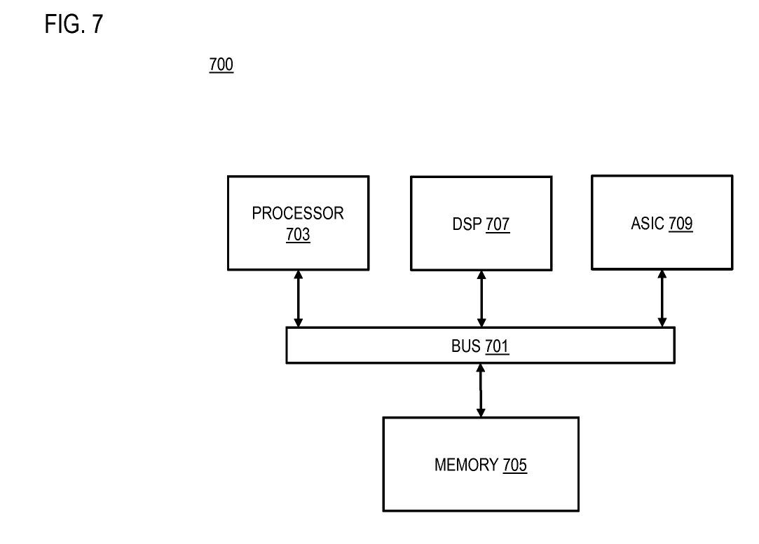

FIG. 3 is a flowchart of a process for providing a flexible and convenient data application interface for mobile web applications with improved security according to one embodiment. In one embodiment, the data store platform 103 performs the process 300 and is implemented in, for instance, a chip set including a processor and a memory as shown in FIG. 7. In step 301, the data store platform 103 determines a request for access to one or more user data items. Next, in step 303, the data store platform 103 processes the request to determine one or more domains associated with the request. Then, in step 305, the data store platform 103 determines one or more access rules associated with the one or more user data items. The one or more access rules specify, at least in part, one or more criteria for determining one or more authorized domains, one or more users, or a combination thereof that have access rights to the one or more data items.

The process continues to step 307 in which the data store platform 103 determines whether to grant the access to the one or more user items based, at least in part, on a comparison of the one or more domains against the one or more criteria, the one or more access rules, or a combination thereof. The comparison of access rules, as discussed above may be a matching of allowed rights such as read, write, delete access etc. Next, in step 309, the data store platform 103 filters the one or more user data items based, at least in part, on the comparison. The access comprises, at least in part, access to the one or more filtered user data items.

Then, in step 311, the data store platform 103 processes one or more headers associated with the request to determine the one or more domains. This processing determines the origin of the request, and determines if a particular domain can be trusted. The request may be a cross-site Extensible Markup Language Hypertext Transfer Protocol Request (XMLHttpRequest) which enables the determination of a trusted domain header. Next, in step 313, the data store platform 103 processes the request to determine one or more credentials associated with the one or more users. The data store platform, in step 315, determines one or more grantable access rights based, at least in part, on the one or more credentials. Next, in step 317, the data store platform 103 determines one or more effective access rights based, at least in part, on a comparison of the access of the request and the one or more grantable access rights. The one or more grantable access rights include, as discussed above, at least in part, a read access, a write access, a delete access, or any combination thereof.

The process continues to step 319 in which the data store platform 103 determines to store the one or more user items in one or more online cloud components, one or more offline data stores, or a combination thereof. Then, in step 321, the data store platform 103 caches the one or more user items from the one or more cloud components to respective ones of the one or more offline data stores based, at least in part, on the one or more domains. The respective ones of the one or more offline data stores are associated with respective ones of the one or more domains. The data store 109, as discussed above, includes one or more offline data stores. Accordingly, the data store 109 may be local and/or remote from the UE 101 or any of the cloud API 107 or application service 111. It should be noted that the data store platform 103, when it determines the origin of the request determines that the request is from one or more services, one or more applications, or a combination thereof, and wherein the one or more access rules are maintained, at least in part, by one or more developers, one or more content stores, one or more third parties, or a combination thereof.

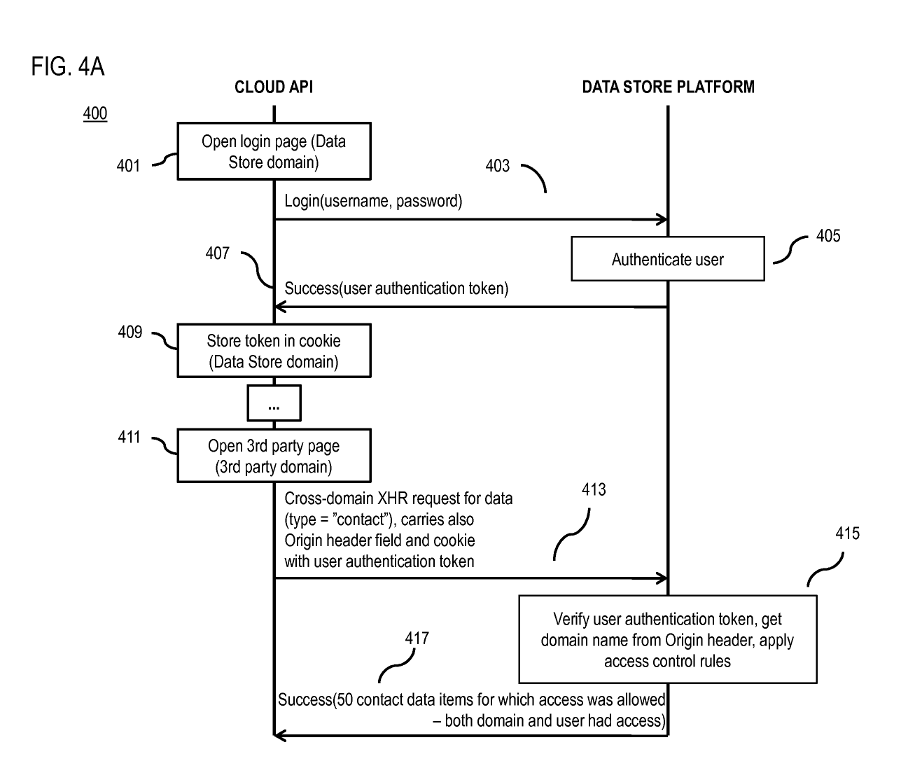

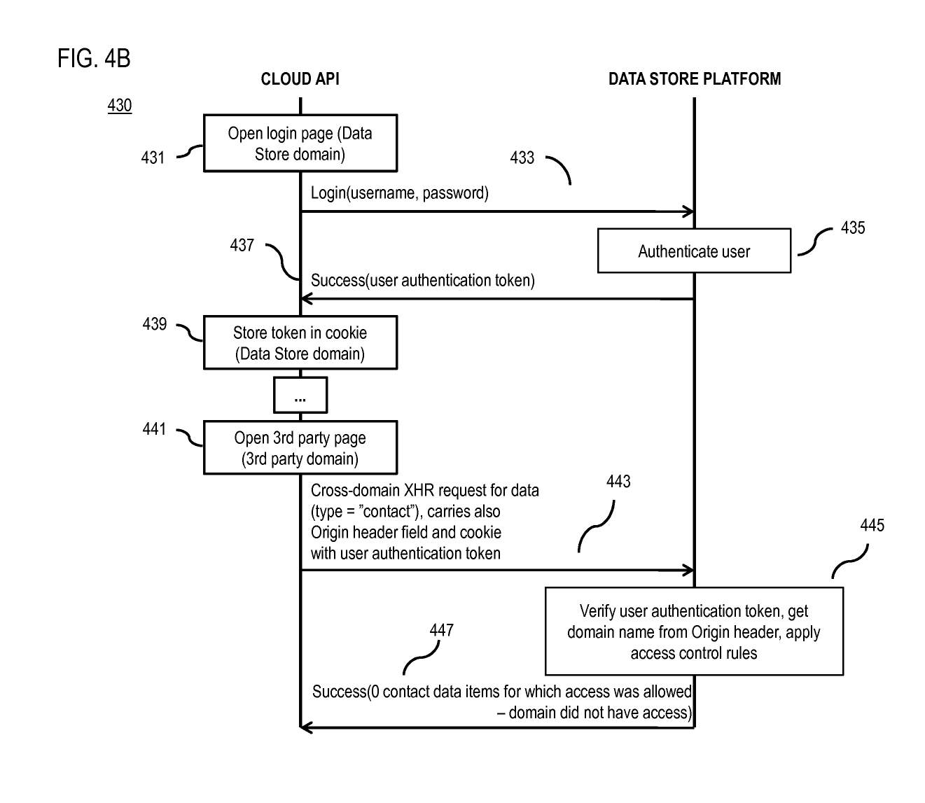

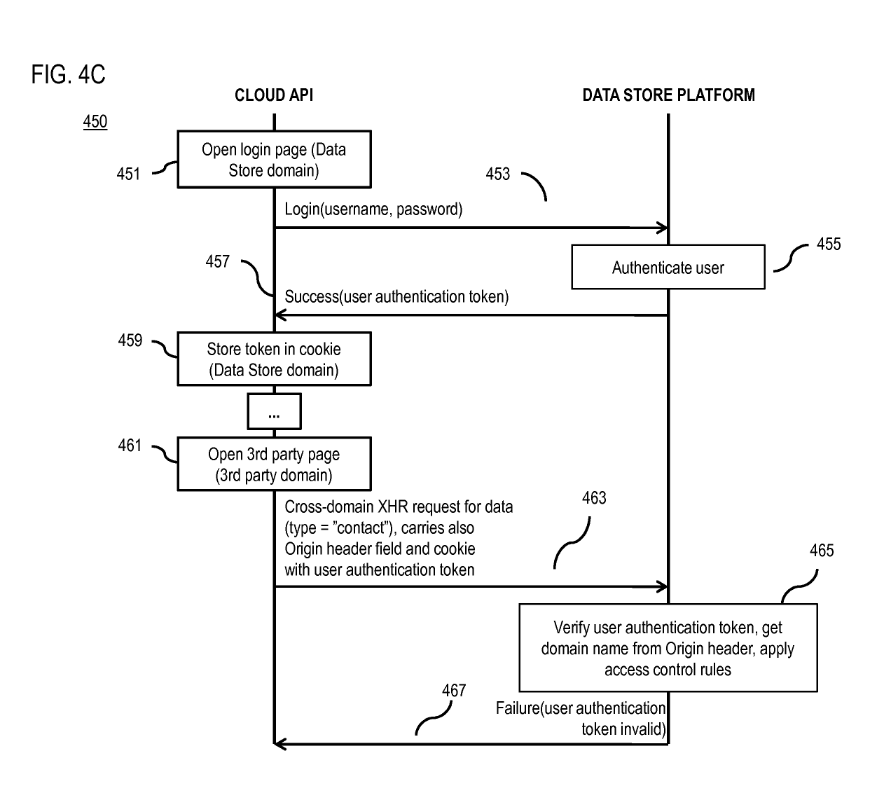

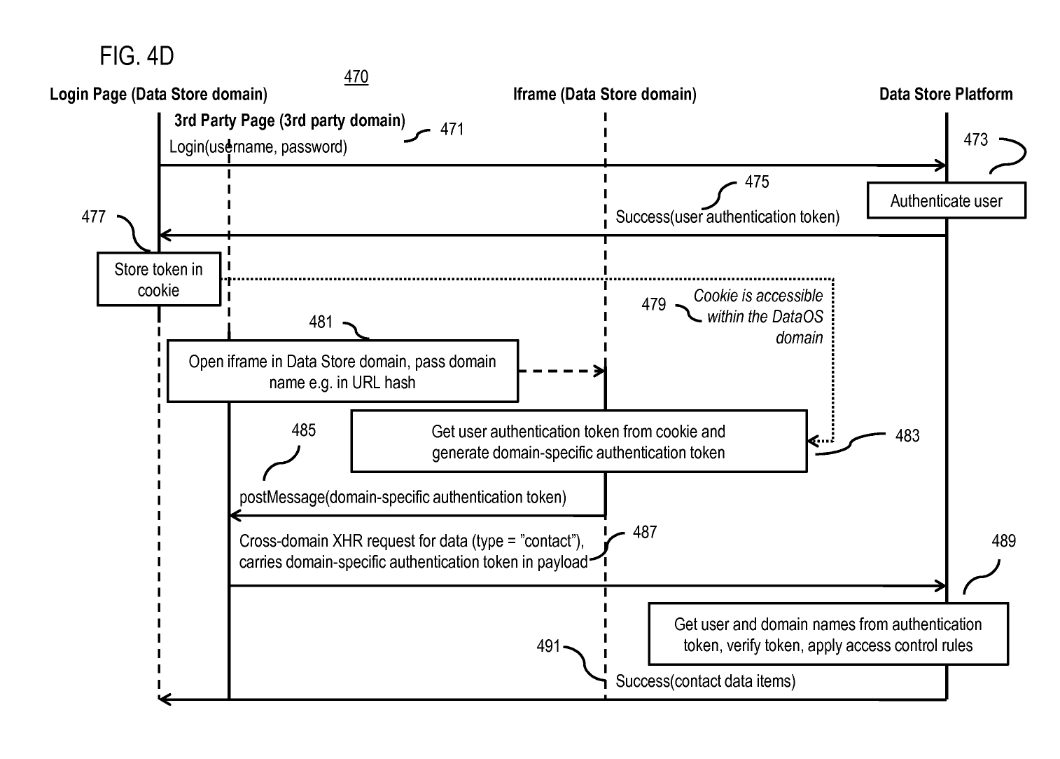

FIGS. 4A-4D are sequence diagrams of the processes discussed with reference to FIG. 3, according to various embodiments.

In FIGS. 4A-4C, when a page from domain A (“third party”) makes a cross-domain XMLHttpRequest (XHR) request to data in domain B (“data store domain”), cookies belonging to domain B are included in the request. Cookies work with Cross-domain XMLHttpRequest (XHR). There are three scenarios that differ only in the last message, the scenarios are as follows:

1. User has allowed the third party domain access to contact data—FIG. 4A

2. User has not allowed the third party domain access to contact data—FIG. 4B

3. User authentication fails, e.g. because user login session has expired—FIG. 4C

In FIG. 4A, which illustrates a process 400, a login page is opened in step 401 at the cloud API 107 (data store domain). Then, in step 403a log-in name and password are entered, the data store platform 103 authenticates the users. When authentication is granted in step 405, and success is indicated in step 407, a token is saved as a cookie at the data store domain in step 409. A third party web page may be opened at step 411 and a cross-domain XHR request for data is sent to the data store platform 103 in step 413. The cross-domain XHR request carries the origin header field and cookie with the user authentication token. The data store platform 103 verifies the user authentication token in step 415, gets the domain name from the origin header and applies any access control rules. Once access is granted, and a success message is received in step 417, the requested data items are sent to cloud API 107.

In FIG. 4B, which illustrates a process 430, a login page is opened in step 431 at the cloud API 107 (data store domain), a log-in name and password are entered in step 433, and the data store platform 103 authenticates the users in step 435. When authentication is granted and success is indicated in step 437, a token is saved as a cookie at the data store domain in step 439. A third party web page may be opened at step 441 and a cross-domain XHR request for data is sent to the data store platform 103 in step 443. The cross-domain XHR request carries the origin header field and cookie with the user authentication token. The data store platform 103 verifies the user authentication token in step 445, gets the domain name from the origin header and applies any access control rules. Access, however, is not granted to the requested data items because the domain was not given access based on the rules in step 447.

In FIG. 4C, which illustrates a process 450, a login page is opened at the cloud API 107 (data store domain) in step 451, a log-in name and password are entered in step 453, and the data store platform 103 authenticates the users in step 455. When success is indicated in step 457 that authentication is granted, a token is saved as a cookie at the data store domain in step 459. A third party web page may be opened in step 46l and a cross-domain XHR request for data is sent to the data store platform 103 in step 463. The cross-domain XHR request carries the origin header field and cookie with the user authentication token. The data store platform 103 verifies the user authentication token in step 465, gets the domain name from the origin header and applies any access control rules. Access, however, is not granted to the requested data items in step 467 because, in this example, the authentication token was invalid or expired.

FIG. 4D illustrates a sequence diagram of a process 470 in which cookies do not work with cross-domain XHR. When page from domain A (“third party”) makes a cross-domain XHR request to server in domain B (“Data Store”), cookies belonging to domain B are not included in the request. The third party domain instead opens a page from the data store domain in an (invisible) iframe and gets a domain-specific authentication token from the iframe using the browser's postMessage API. The name of the third party domain is passed to the iframe e.g., in a Universal Resource Locator (URL) hash part, or alternatively using the postMessage API—a message event contains the domain name of the page that sent the message. The iframe can access the cookie that stores the user authentication token and use that to generate a domain specific authentication token.

The user authentication token itself must not be given to pages from third party domains, since they could pass it to the third party server, creating a situation where the user is effectively logged in on a compromised machine. The domain specific authentication token can be simply a secure hash of the user authentication token and the domain name, this allows it to be generated on client side. The token should also contain the user and domain name in clear text so that verification process knows what to check against. Alternatively, if generated on the server side, it can be a random string that the server can map to a (user, domain) pair (not shown in message diagram). However, an extra server request would then be needed to generate the domain-specific authentication token. When postMessage is used to return the domain-specific authentication token, the message recipients can be limited to the domain that the token belongs to (domain A), so the token cannot be captured by other domains. The token is sent as payload data (rather than header field) in the cross-domain XHR request.

For example, a log-in name and password are entered at a log in page in step 471, and the data store platform 103 authenticates the user in step 473. When success is indicated in step 475 that authentication is granted, a token is saved as a cookie at the data store domain in step 477. The cookie is accessible within the data store domain at step 479 and is used to get the user authentication token and generate a domain-specific authentication token at step 483. Alternatively, an iframe may be opened in the data store domain, and the domain name may be passed in a URL hash in step 481. The domain-specific authentication token may then be returned to the third party page in step 485 using e.g. a message that is sent using the postMessage API. This message may be limited so that it can only be received by pages in the domain that the authentication token belongs to. A cross-domain XHR request for data is sent to the data store platform 103 in step 487. The cross-domain XHR request carries the domain-specific authentication token. The data store platform 103 gets the user name and domain name from the authentication token, verifies the authentication token, and applies any access control rules in step 489. Access is then granted to the requested data items in step 491.

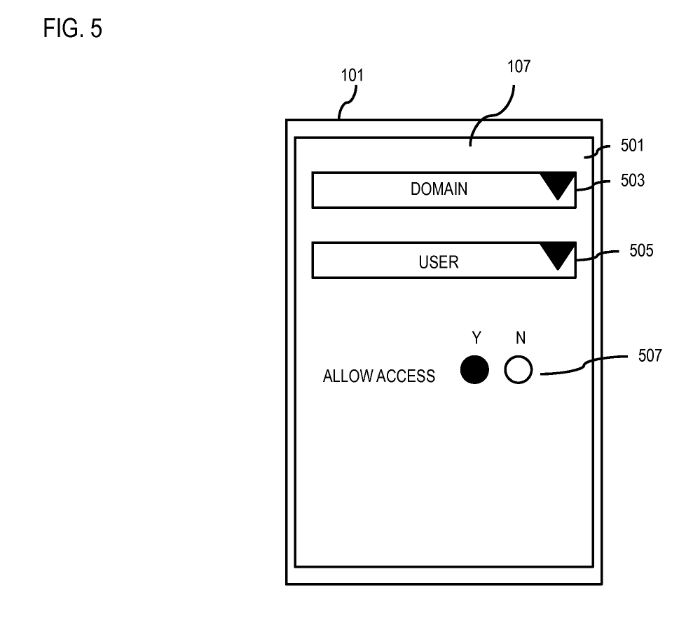

FIG. 5 illustrates an example user interface 501 of the cloud API 107 resident on the UE 101, according to one embodiment. The user interface 501 allows a user to set various preferences for granting certain access rights to the data store 109. For example, a user may select any domain available in the drop down box 503 (such as a domain from which data has been created, or from which access has been granted historically), or may edit the domain to include a custom domain for granting access to the data store 109. Alternatively, or in addition to the domain access, the user may grant specific user access using drop down box 505, which may have a list of users that have historically been granted access, or are associated with the creation of specific data available in data store 109. The user may also add additional users for allowing access as the user's desire. Access may be granted using radio buttons 507, for example. This user interface 501 is merely an example of how a user may customize preferences for granting access right. The user interface 501 in no way limits the application of any other user interface design that may enable the functionality of the system 100 or facilitate the processes described above.

The processes described herein for providing a flexible and convenient data application interface for mobile web applications with improved security may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

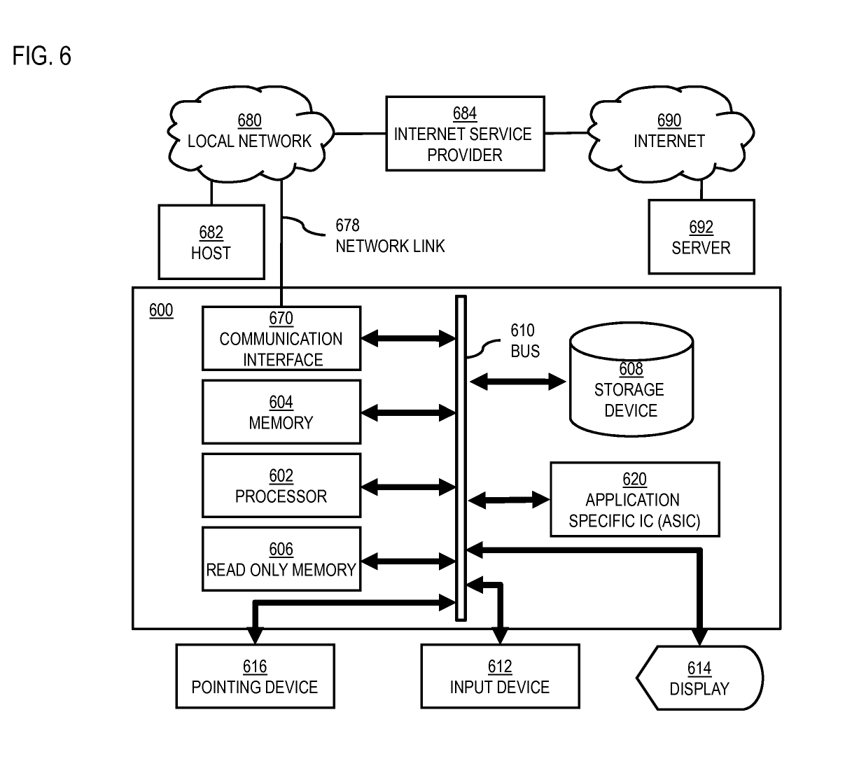

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a flexible and convenient data application interface for mobile web applications with improved security as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a flexible and convenient data application interface for mobile web applications with improved security.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to provide a flexible and convenient data application interface for mobile web applications with improved security. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing a flexible and convenient data application interface for mobile web applications with improved security. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a flexible and convenient data application interface for mobile web applications with improved security, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing a flexible and convenient data application interface for mobile web applications with improved security to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide a flexible and convenient data application interface for mobile web applications with improved security as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing a flexible and convenient data application interface for mobile web applications with improved security.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a flexible and convenient data application interface for mobile web applications with improved security. The memory 705 also stores the data associated with or generated by the execution of the inventive steps.

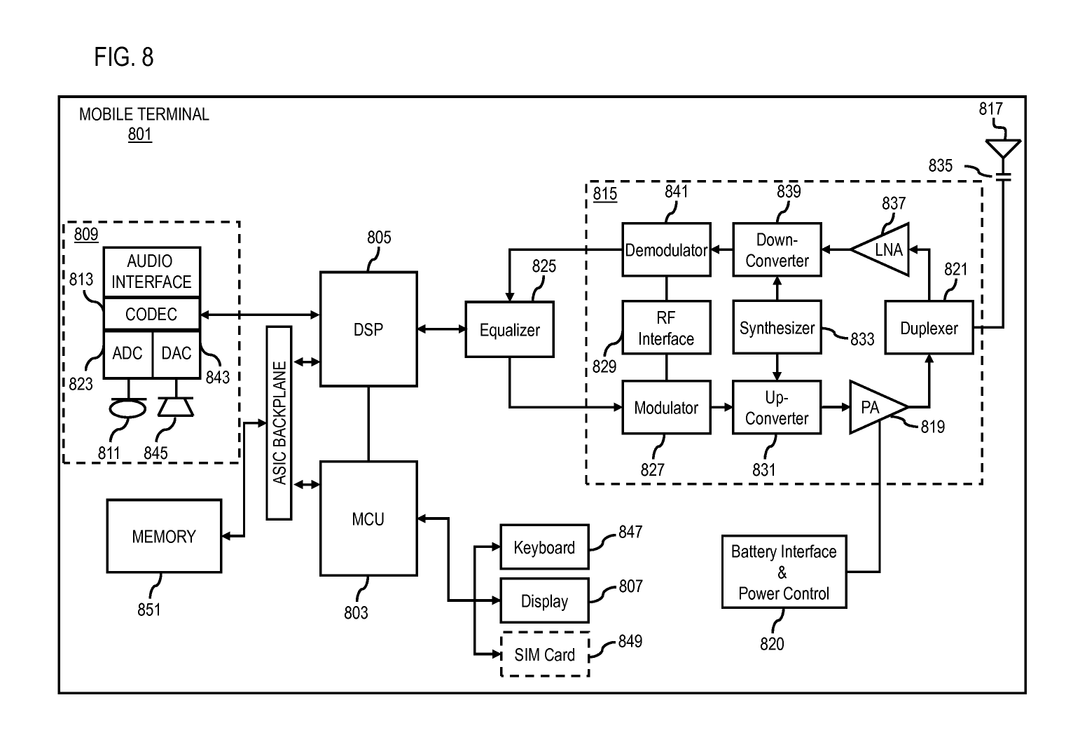

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing a flexible and convenient data application interface for mobile web applications with improved security. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a flexible and convenient data application interface for mobile web applications with improved security. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide a flexible and convenient data application interface for mobile web applications with improved security. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request for access to one or more user data items;
a processing of the request to determine one or more domains associated with the request;
one or more access rules associated with the one or more user data items, wherein the one or more access rules specify, at least in part, one or more criteria for determining one or more authorized domains, one or more users, or a combination thereof that have access rights to the one or more data items; and
at least one determination of whether to grant the access to the one or more user items based, at least in part, on a comparison of the one or more domains against the one or more criteria, the one or more access rules, or a combination thereof.

2. A method of claim 1, wherein the (1) data and/or (2) information and/or (3) at least one signal are further based, at least in part, on the following:
a filtering of the one or more user data items based, at least in part, on the comparison,
wherein the access comprises, at least in part, access to the one or more filtered user data items.

3. A method of claim 1, wherein the (1) data and/or (2) information and/or (3) at least one signal are further based, at least in part, on the following:
a processing of one or more headers associated with the request to determine the one or more domains.

4. A method of claim 3, wherein the request is a cross-site Extensible Markup Language Hypertext Transfer Protocol Request (XMLHttpRequest).

5. A method of claim 1, wherein the (1) data and/or (2) information and/or (3) at least one signal are further based, at least in part, on the following:
a processing of the request to determine one or more credentials associated with the one or more users;
an authentication of the one or more user credentials;
at least one determination of one or more grantable access rights based, at least in part, on the authentication of the one or more credentials; and
at least one determination of one or more effective access rights based, at least in part, on a comparison of the access of the request and the one or more grantable access rights.

6. A method of claim 5, wherein the one or more grantable access rights include, at least in part, a read access, a write access, a delete access, or a combination thereof.

7. A method of claim 1, wherein the (1) data and/or (2) information and/or (3) at least one signal are further based, at least in part, on the following:
at least one determination to store the one or more user items in one or more online cloud components, one or more offline data stores, or a combination thereof.

8. A method of claim 7, wherein the (1) data and/or (2) information and/or (3) at least one signal are further based, at least in part, on the following:
a caching of the one or more user items from the one or more cloud components to respective ones of the one or more offline data stores based, at least in part, on the one or more domains,
wherein the respective ones of the one or more offline data stores are associated with respective ones of the one or more domains.

9. A method of claim 7, wherein the one or more offline data store includes at least one browser local storage.

10. A method of claim 1, wherein the request is from one or more services, one or more applications, or a combination thereof, and wherein the one or more access rules are maintained, at least in part, by one or more developers, one or more content stores, one or more third parties, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a request for access to one or more user data items;
process and/or facilitate a processing of the request to determine one or more domains associated with the request;
determine one or more access rules associated with the one or more user data items, wherein the one or more access rules specify, at least in part, one or more criteria for determining one or more authorized domains, one or more users, or a combination thereof that have access rights to the one or more data items; and
determine whether to grant the access to the one or more user items based, at least in part, on a comparison of the one or more domains against the one or more criteria, the one or more access rules, or a combination thereof.

12. An apparatus of claim 11, wherein the apparatus is further caused to:
cause, at least in part, a filtering of the one or more user data items based, at least in part, on the comparison,
wherein the access comprises, at least in part, access to the one or more filtered user data items.

13. An apparatus of claim 11, wherein the apparatus is further caused to:
process and/or facilitate a processing of one or more headers associated with the request to determine the one or more domains.

14. An apparatus of claim 13, wherein the request is a cross-site Extensible Markup Language Hypertext Transfer Protocol Request (XMLHttpRequest).

15. An apparatus of claim 11, wherein the apparatus is further caused to:
process and/or facilitate a processing of the request to determine one or more credentials associated with the one or more users;
authenticate the one or more user credentials;
determine one or more grantable access rights based, at least in part, on the authentication of the one or more credentials; and
determine one or more effective access rights based, at least in part, on a comparison of the access of the request and the one or more grantable access rights.

16. An apparatus of claim 15, wherein the one or more grantable access rights include, at least in part, a read access, a write access, a delete access, or a combination thereof.

17. An apparatus of claim 11, wherein the apparatus is further caused to:
determine to store the one or more user items in one or more online cloud components, one or more offline data stores, or a combination thereof.

18. An apparatus of claim 17, wherein the apparatus is further caused to:
cause, at least in part, a caching of the one or more user items from the one or more cloud components to respective ones of the one or more offline data stores based, at least in part, on the one or more domains,
wherein the respective ones of the one or more offline data stores are associated with respective ones of the one or more domains.

19. An apparatus of claim 17, wherein the one or more offline data store includes at least one browser local storage.

20. An apparatus of claim 11, wherein the request is from one or more services, one or more applications, or a combination thereof, and wherein the one or more access rules are maintained, at least in part, by one or more developers, one or more content stores, one or more third parties, or a combination thereof.

21-48. (canceled)
